(19) United States
(12) Patent Application Publication
(10) Pub. No.: US 2026/0145689 A1
(43) Pub. Date: May 28, 2026

(54) VEHICLE AND CONTROL METHOD

(71) Applicants: Hyundai Motor Company, Seoul (KR); Kia Corporation, Seoul (KR)

(72) Inventor: Kwan Ho KIM, Hwaseong-Si (KR)

(21) Appl. No.: 19/205,162

(22) Filed: May 12, 2025

(30) Foreign Application Priority Data
Nov. 22, 2024 (KR) 10-2024-0167910

(51) Int. Cl. B60W 50/00; B60N 2/00; B60W 40/08; G06V 20/59; G06V 40/10

(52) U.S. Cl. CPC B60W 50/0098; B60N 2/0025; B60N 2/0027; B60W 40/08; G06V 20/593; G06V 40/10; B60W 2420/22; B60W 2420/403; B60W 2420/408; B60W 2540/043; B60W 2540/227

(57) ABSTRACT

A vehicle may include a sensor unit configured to detect an occupant entering the vehicle, and a control device configured to determine occupant information for each seat based on a detection signal from the sensor unit and selectively control locking and unlocking of at least one of a door or a window of a seat on which the occupant sits according to the occupant information.

### CROSS-REFERENCE TO RELATED APPLICATION

This application claims priority to and the benefit of Korean Patent Application No. 10-2024-0167910, filed on Nov. 22, 2024, in the Korean Intellectual Property Office, the entire disclosure of which is incorporated herein by reference in its entirety for all purposes.

### TECHNICAL FIELD

The present invention relates to a vehicle and a control method, through which it is possible to automatically identify an occupant of a vehicle and safely protect the occupant.

### BACKGROUND

Generally, when a child sits in a vehicle, the child sits in a back seat of the vehicle to protect the child. If a child who sits in the back seat were to open a window or a door while the vehicle is driving, a very dangerous situation would occur. Accordingly, a child lock system may prevent a child who sits in the back seat from opening a window or a door at will.

Some child lock systems allow a driver to operate the child lock system by, for example, directly manipulating a switch to implement the child lock system. Having to manually set each door and/or window individually may inconvenience the driver. In addition, the driver may accidentally fail to operate the child lock. The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a vehicle and control method. A vehicle may comprise: a sensor configured to generate a detection signal associated with an occupant entering the vehicle; a processor; and a memory storing at least one instruction that, when executed by the processor communicating with the memory, is configured to cause the vehicle to: determine, based on the detection signal from the sensor, occupant information for a plurality of seats of the vehicle; and selectively control, based on the occupant information, locking or unlocking of at least one of a door associated with a seat on which the occupant sits or a window associated with the seat.

A method performed by an apparatus of a vehicle may comprise: detecting, via a sensor installed in the vehicle, an occupant entering the vehicle; determining, based on the detected occupant, a position of the occupant in a seat of the vehicle, and determining, based on the position, occupant information of the occupant; and selectively controlling, based on the occupant information, locking or unlocking of at least one of a door associated with the seat or a window associated with the seat.

A vehicle may comprise: a sensor configured to detect one or more characteristics of an occupant of a seat of the vehicle; a processor; and a memory storing at least one instruction that, when executed by the processor communicating with the memory, is configured to cause the vehicle to: classify, based on the detected one or more characteristics from the sensor, the occupant of the seat of the vehicle as one of: an adult; a child; an infant/toddler; or a pet; and selectively control, based on the classification of the occupant, activation of a power lock of at least one of a door associated with the seat or a window associated with the seat.

These and other features and advantages are described in greater detail below.

### BRIEF DESCRIPTION OF THE DRAWINGS

FIG. 1 is a configuration diagram of a vehicle according to an example of the present disclosure; and

FIG. 2 is a flowchart illustrating a control method according to an example of the present disclosure.

Throughout the drawings and the detailed description, unless otherwise described or provided, the same, or like, drawing reference numerals may be understood to refer to the same, or like, elements, features, and/or structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and/or equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order (as will be indicated herein).

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Advantages and/or features of the present disclosure and/or methods of achieving the advantages and/or features will be clear with reference to examples described in detail below together with the accompanying drawings. However, the present disclosure is not limited to the examples disclosed herein but may be implemented in various forms. The examples of the present disclosure are provided so that the present disclosure is completely disclosed, and a person with ordinary skill in the art can fully understand the scope of the present disclosure. The scope present disclosure will be defined only by the scope of the appended claims. The terms used in the present specification are for explaining the examples, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the example, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

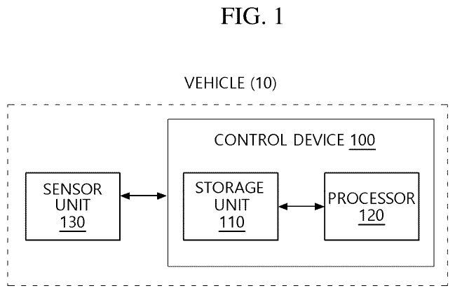

FIG. 1 is a configuration diagram of a vehicle according to an example of the present disclosure.

Referring to the drawing, a vehicle 10 may include a control device 100 (e.g., a controller and/or controlling computing device, herein), a storage unit 110 (e.g., a storage and/or memory), a processor 120, and a sensor unit 130 (e.g., a sensor and/or comprising one or more sensors).

The control device 100 may be formed integrally with internal components of the vehicle 10, implemented as a separate device, and/or connected to the internal components of the vehicle by a separate connection means (e.g., by wired and/or wireless communications/connections).

The control device 100 (e.g., controller) may include a communication device/communication interface communicating with other controllers or a sensor to control one or more functions and/or operations in charge, a memory storing an operation system, a logic command, and input/output information, and/or one or more processors performing determination, calculation, and decision necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., vehicle).

Communication interface(s) (also referred to as communication device(s), communicator(s), communication module(s), communication unit(s), etc.) may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

The control device 100 may be implemented as a separate independent device. In this case, the control device 100 may be connected to various internal components of the vehicle via wired and/or wireless communication. For example, the control device 100 may communicate with a module, such as the sensor unit 130 of the vehicle, via a vehicle network, such as a controller area network (CAN), a local interconnect network (LIN), and/or Ethernet.

The storage unit 110 may include a memory. The storage unit 110 may be provided inside the processor 120, the control device 100, and/or the vehicle 10 or provided as a separate memory. In an example, the storage unit 110 may be formed by combining a non-volatile memory, such as a hard disk drive, a flash memory, an electrically erasable programmable read-only memory (EEPROM), a static RAM (SRAM), a ferro-electric RAM (FRAM), a phase-change RAM (PRAM), and/or a magnetic RAM (MRAM) and/or a volatile memory, such as a DRAM, a synchronous DRAM (SDRAM), and/or a double data rate-SDRAM (DDR-SDRAM).

The storage unit 110 may store occupant information and/or allow the processor 120 to access (e.g., request and/or retrieve) and/or utilize the information (e.g., in real time).

The occupant information may include information about adults, students and/or children, infants and/or toddlers and/or pets. Occupants may be classified into at least three categories including 1) adults, 2) children, and 3) infants/toddlers and pets. The classification may be used as a criterion for determining which of the three categories an occupant entering the vehicle 10 belongs to. Each category may be classified by numerically quantifying a form (e.g., a seated height and/or a shape and/or dimension and/or position), weight, and the like of the occupant.

The occupant's characteristics (e.g., an estimated age range) may be determined based on various sensing data. One or more in-cabin cameras may be used to detect facial landmarks of the occupant and a plurality of key points on the face of the occupant for an age prediction. In some implementations, facial proportions that change with age (e.g., a ratio of facial width to height) may be detected for an age prediction. Based on one or more images capturing the face of the occupant, skin texture patterns may be evaluated to classify different age groups (e.g., adults, children, adolescents, infants, toddlers, etc.) In-cabin radars may use millimeter waves to detect body sizes and movements of the occupant(s) for an age prediction of each occupant. Multi-sensor fusion may be performed to combine sensing data from various sensors to generate a comprehensive age profile for each occupant. In some implementations, movement pattern may be detected for an age prediction. For example, younger passengers display unique movement patterns that are distinct from movement patterns of adults.

The processor 120 may be electrically, communicatively and/or operatively connected to the storage unit 110 and/or the sensor unit 130.

The processor 120 may determine whether there is an occupant in each seat. The processor 120 may determine the occupant information based on a detection signal transmitted from the sensor unit 130. For example, the processor 120 may check whether the occupant has entered and/or sat on a passenger seat in a first row, and/or a driver's-seat-side seat and/or a middle seat and/or a passenger-seat-side seat in a second row, etc. The processor 120 may determine whether the occupant is an adult, a child, or an infant/toddler or pet (e.g., may classify the occupant as an adult, a child, or an infant toddler or pet).

The control device 100 may selectively control the locking and/or unlocking of at least one of a door and/or window near the seat on which the classified occupant sits. The locking and/or locking herein may refer to individually locking and/or locking the at least one of the door and/or window and/or activating and/or deactivating a window control lock and/or a power child lock of the door and/or window, where activating the window control lock and/or power child lock disables controls for the window and/or door accessible to the occupant of the seat associated with the window and/or door, and deactivating the window control lock and/or power child lock enables the controls accessible to the occupant. The locking and/or unlocking may be selectively controlled according to/based on the occupant information determined by the processor 120.

For example, the control device 100 may lock a door and and/or window associated with a detected occupant based on a determination that the occupant information is a classification of an infant/toddler or pet. The door and the window can thus be prevented from being opened unintentionally by the infant/toddler or the pet.

Also, or alternatively, the control device 100 may lock the door and/or unlock the window based on a determination, based on the occupant information, that the occupant is a child. The door can thus be prevented from being opened unintentionally, which can safely protect the child. The window may be unlocked so that the occupant may control the window.

Also, or alternatively, the control device 100 may unlock the door and the window based on a determination, based on the occupant information, that the occupant is an adult. Accordingly, the occupant may control the door and the window by himself or herself.

If the control device 100 detects an operation of opening a door from outside a vehicle (e.g., after the driving of the vehicle has ended and/or while the vehicle is stopped), the control device 100 may control the locked door and window to be unlocked (e.g., together). For example, in a case in which a child gets into the car and sits on a passenger-seat-side seat in a second row of the vehicle, a door and a window corresponding to the passenger-seat-side seat in the second row may be both locked (e.g., by the control device 100). When/if the door of the corresponding seat is opened from outside after/while the vehicle is stopped (e.g., as indicated by a sensor associated with an outside handle of the door detecting and/or communicating manipulation of the outside handle of the door), the door and the window may both be controlled to be unlocked. One or more doors and/or windows of other seats may also be controlled to be unlocked together.

The sensor unit 130 may be configured to detect an occupant entering the vehicle 10. In an example, the sensor unit 130 may include a camera and/or a radar. In addition, the sensor unit 130 may further include one or more weight sensors (e.g., weight sensors in each of the passenger seats). The camera and/or the radar may be installed on an upper portion of the inside of the vehicle 10, and/or a location in/on the vehicle configured to image/sense one or more of the passenger seats. The one or more weight sensors may be installed on one or more passenger seats.

The control device 100 may be configured to transmit/send, based on a door of the vehicle being opened from the outside of the vehicle 10, a detection request signal to the sensor unit 130. The sensor unit 130 may be configured to recognize/image an occupant of a seat corresponding to the door, primarily via the camera. For example, the sensor unit 130 may recognize an overall shape and/or related features, such as a position and/or seated height of the occupant who sits on a seat near/corresponding to the opened door. The sensor unit 130 may transmits a signal indicating the recognized shape and/or related features to the control device 100.

In the case of the occupant being a children, an infant/toddler, and/or a pet, there may be cases in which the occupant are not clearly recognized via the camera (e.g., because the occupant is are covered/obscured by a seat, a car seat, or the like). Accordingly, if the occupant information cannot be clearly determined from a camera signal, a radar detection request signal may be transmitted to the sensor unit 130. The sensor unit 130 may be configured to detect the occupant secondarily via the radar. The radar may transmit a signal, received by being reflected from the occupant, to the control device 100. In an example, the radar may include a radar of a rear occupant alert (ROA) system. In an example, the sensor unit 130 may be configured to detect the occupant primarily with the radar and/or with the radar and camera in combination.

The weight sensor may be configured to detect a weight of an occupant who sits on a seat associated with the weight sensor. The weight sensor of the seat on which the occupants sits may detect a load due to the weight of the occupant and transmit/send a signal indicating the detected load to the control device 100.

The control device 100 may determine occupant information based on (e.g., by combining) the signals transmitted from the camera, radar and/or the weight sensor(s).

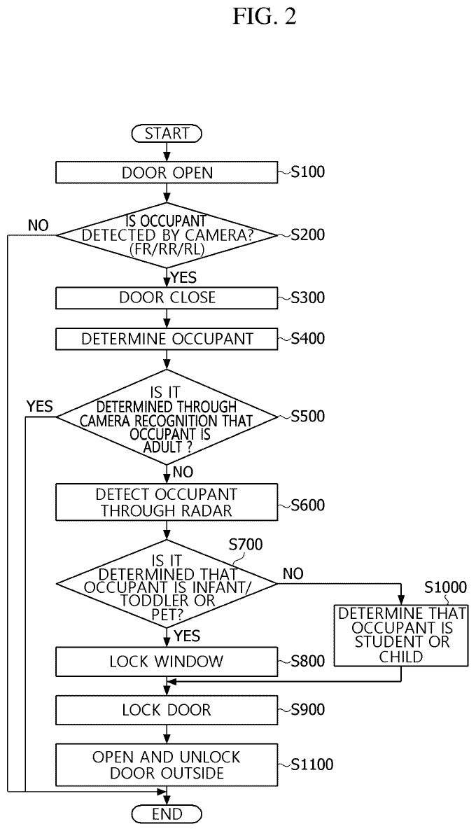

FIG. 2 is a flowchart for describing a method of controlling a vehicle according to an example of the present disclosure. For convenience, FIG. 2 is described by way of an example in which the steps are performed by a processor circuit. One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

Based on a door of the vehicle 10 being opened (S100), an occupant entering the vehicle may be detected (S200).

The detection of the occupant may be initiated based on the door being opened from the outside of the vehicle (e.g., based on a door sensor detecting manipulation of the door handle from the outside and/or based on detecting a door is opened while the inside of the vehicle 10 and/or a seat associated with the door is empty). The control device 100 may transmit/send, based on the door being opened, an occupant detection request signal to the sensor unit 130.

The sensor unit 130 may detect an occupant of a seat corresponding to the door determined to be opened (e.g., and/or of each seat based on the door being opened). The sensor unit 130 may detect the occupant (and/or occupants) based on one or more images from one or more cameras. The one or more cameras may be configured to detect/image an occupant in each passenger seat (e.g., a front right FR seat, a rear right RR seat, a rear left RL seat, a middle seat, a second row right seat, a second row left seat, etc.). The sensor unit 130 may recognize a position and/or one or more other visual features of the occupant based on one or more images of the seat acquired via the camera. Also, or alternatively, the sensor unit 130 may detect a load on the seat (e.g., via a weight sensor associated with the seat). A signal indicating the detected occupant, a load measurement on the seat, a position and/or one or more visual features of the occupant based on an image acquired by the camera, and/or one or more images acquired by the camera, may be transmitted to the control device 100. Based on the door of the vehicle 10 being detected to be closed (S300), it may be recognized that the occupant is on the seat corresponding to the now closed door. If the occupant is not detected in a seat corresponding to the door, the corresponding door and/or window may be controlled to be unlocked.

If it is confirmed that the occupant is in the vehicle (e.g., based on a signal from the sensor unit 130 and/or based on, the control device 100 may determine occupant information based on the signal transmitted from the sensor unit 130 (S400) (e.g., based on one or more images captured by the camera and/or load information from a weight sensor of the sensor unit 130). For example, object recognition may be applied, by the sensor unit 130 and/or the control device 100, to the one or more images from the camera and the occupant information (e.g., position, height, etc.) may be determined (e.g., by the sensor unit 130 and sent to the control device 100, or by the control device 100 based on images and/or object recognition results received from the sensor unit 130) based on the results of the object recognition. The control device 100 may determine which category the occupant corresponds to based on the occupant information. For example, the occupant information may be used to classify an occupant as an adult, a child, and an infant/toddler or pet.

If the occupant is categorized as an adult, the door and the window may be controlled to be unlocked (S500).

If the occupant information cannot be determined based on the camera signal and/or weight sensor signal, a radar detection request signal may be transmitted to the sensor unit 130, and the sensor unit 130 may operate to detect the occupant secondarily via the radar (S600). In at least some examples, the radar may be used in addition to and/or instead of one or more of a camera signal and/or weight sensor signal (e.g., for determining whether occupant is detected S200 and/or to determine occupant information S400).

Through radar detection, the control device 100 may determine whether the occupant is an infant/toddler or pet (S700). The control device 100 may also, or alternatively, determine whether the occupant is an infant/toddler or pet (S700) based on occupant information from object recognition of one or more images from the camera and/or the load detected by the weight sensor.

Based on the occupant information, the control device 100 may selectively control the locking and/or unlocking of at least one of a door and/or window near a seat on which the occupant sits.

Specifically, if it is determined that the occupant information is an infant/toddler or pet (S700—Yes), the control device 100 may control each of the window and door to be locked (S800 and S900).

If it is determined that the occupant information does not correspond to an infant/toddler or a pet in operation S700 (S700—No), the control device 100 may determine that the occupant information corresponds to a child (S1000). The control device 100 may control, based on the occupant information corresponding to a child, only the door to be locked, without locking the window (S900).

In an example, the locking and/or unlocking of the door and the window may be performed by outputting a control signal that controls the operation of a door lock, a window driving motor, or the like.

After driving of the vehicle has ended (e.g., the vehicle is stopped, the engine of the vehicle is stopped, etc.), control of the locked door and window to be unlocked may be performed (S1100).

For example, if the locked door is opened from the outside of the vehicle while the vehicle 10 is stopped, the corresponding door and window may be unlocked. Any locked doors and/or windows, including or in addition to the opened door, may be controlled to be unlocked.

The present disclosure is directed to automatically identifying whether an occupant entering a vehicle is an adult or a child, and based on this, automatically controlling locking and unlocking of a door and window near a seat on which the corresponding occupant sits.

Objects of the present disclosure are not limited to the above-described object, and other objects that are not mentioned will be able to be clearly understood by those skilled in the art from the following description.

According to the present disclosure, a vehicle may include a sensor unit configured to detect an occupant entering the vehicle, and a control device configured to determine occupant information for each seat based on a detection signal from the sensor unit and selectively control locking and unlocking of at least one of a door and a window of a seat on which the occupant sits according to the occupant information.

The occupant information may include categories of adults, children, and infants/toddlers and pets.

The control device may lock the door and the window when it is determined from the occupant information that the occupant is an infant/toddler or pet.

The control device may lock the door and unlock the window when it is determined from the occupant information that the occupant is a child.

The control device may unlock the door and the window when it is determined from the occupant information that the occupant is an adult.

The control device may control a locked door or window to be unlocked upon detecting an operation of opening the locked door from an outside of the vehicle.

The sensor unit may include a camera and a radar, and may be configured to recognize a form of the occupant primarily through the camera and detect the occupant secondarily through the radar.

The sensor unit may include a weight sensor and may be configured to detect a weight of the occupant who sits on the seat.

According to the present disclosure, a control method may include detecting an occupant entering a vehicle, checking a position of an occupant for each seat and determining occupant information, and selectively controlling locking and unlocking of at least one of a door and a window near a seat on which the occupant sits based on the occupant information.

The detecting of the occupant may be initiated when the door is opened from an outside of the vehicle while the inside of the vehicle is empty.

The determining of the occupant information may include determining which category the occupant corresponds to among the occupant information that classifies the occupant as an adult, a child, or an infant/toddler or pet.

The controlling of the locking and unlocking of the door and the window may include locking the door and the window when it is determined from the occupant information that the occupant is an infant/toddler or pet.

The controlling of the locking and unlocking of the door and the window may include locking the door and unlocking the window when it is determined from the occupant information that the occupant is a child.

The controlling of the locking and unlocking of the door and the window may include unlocking the door and the window when it is determined from the occupant information that the occupant is an adult.

The control method may further include unlocking the locked door and window together, wherein the controlling of the locked door and window to be unlocked may be initiated when the locked door is opened from an outside of the vehicle.

According to examples of the present disclosure, it is possible to automatically identify whether an occupant entering a vehicle is an adult or a child, and based on this, automatically control locking and unlocking of a door and window near a seat on which the corresponding occupant sits. Accordingly, it is possible to more safely protect a child in the vehicle.

Effects of the present disclosure are not limited to the above-described effects, and other effects that are not mentioned will be able to be clearly understood by those skilled in the art from the following description.

The examples of the present disclosure disclosed herein are not the totality of all available combinations. Instead, the examples described herein are representative and illustrative of the present disclosure, and descriptions of various examples may be applied independently or may be applied through a combination of two or more.

A number of examples have been described herein. Nevertheless, it will be understood that various modifications may be made without deviating from the scope of the present disclosure. For example, suitable results may be achieved if the described techniques are performed in a different order and/or if components in a described system, architecture, device, and/or circuit are combined in a different manner and/or replaced or supplemented by other components or their equivalents. Accordingly, other implementations are within the scope of the following claims.

While this disclosure includes specific examples, it will be apparent to one skilled in the relevant art that various changes in form and/or details may be made in these examples without departing from the spirit and scope of the claims and their equivalents. The examples described herein are to be considered in a descriptive/illustrative sense only, and not for purposes of limitation. Descriptions of features and/or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle comprising:
a sensor configured to generate a detection signal associated with an occupant entering the vehicle;
a processor; and
a memory storing at least one instruction that, when executed by the processor communicating with the memory, is configured to cause the vehicle to:
determine, based on the detection signal from the sensor, occupant information for a plurality of seats of the vehicle; and
selectively control, based on the occupant information, locking or unlocking of at least one of a door associated with a seat on which the occupant sits or a window associated with the seat.

2. The vehicle of claim 1, wherein the occupant information comprises categories of one or more of adults, children, infants/toddlers or pets.

3. The vehicle of claim 2, wherein the at least one instruction, when executed by the processor communicating with the memory, is configured to cause the vehicle to, based on the occupant information indicating the occupant is an infant/toddler or a pet, lock the door and the window.

4. The vehicle of claim 2, wherein the at least one instruction, when executed by the processor communicating with the memory, is configured to cause the vehicle to, based on the occupant information indicating the occupant is a child, lock the door and unlock the window.

5. The vehicle of claim 2, wherein, based on the occupant information indicating the occupant is an adult, the at least one instruction, when executed by the processor communicating with the memory, is configured to cause the vehicle to unlock the door and the window.

6. The vehicle of claim 2, further comprising a second sensor configured to detect opening a locked door from an outside of the vehicle,
wherein the at least one instruction, when executed by the processor communicating with the memory, is configured to cause the vehicle to control, based on a signal from the second sensor indicating the opening the locked door from the outside of the vehicle, the locked door or a window associated with the locked door to be unlocked.

7. The vehicle of claim 1, wherein the sensor comprises a camera and a radar, and wherein the sensor is configured to:
recognize one or more physical characteristics of the occupant via the camera; and
detect the occupant in the seat via the radar.

8. The vehicle of claim 1, wherein the sensor comprises a weight sensor configured to detect a weight of the occupant while sitting on the seat.

9. A method performed by an apparatus of a vehicle, the method comprising:
detecting, via a sensor installed in the vehicle, an occupant entering the vehicle;
determining, based on the detected occupant, a position of the occupant in a seat of the vehicle, and
determining, based on the position, occupant information of the occupant; and
selectively controlling, based on the occupant information, locking or unlocking of at least one of a door associated with the seat or a window associated with the seat.

10. The method of claim 9, wherein the detecting of the occupant is initiated based on detection of opening of a door of the vehicle from an outside of the vehicle while an inside of the vehicle is empty.

11. The control method of claim 9, wherein the determining of the occupant information comprises determining a category of the occupant that classifies the occupant as one an adult, a child, an infant/toddler or a pet.

12. The method of claim 11, wherein the controlling of the locking or unlocking of the at least one of the door or the window comprises:
based on the occupant information indicating that the occupant is an infant/toddler or a pet, locking the door and the window.

13. The method of claim 11, wherein the controlling of the locking or unlocking of the at least one of the door or the window comprises:
based on the occupant information indicating that the occupant is a child, locking the door and unlocking the window.

14. The method of claim 11, wherein the controlling of the locking or unlocking of the at least one of the door or the window comprises:
based on the occupant information indicating that the occupant is an adult, unlocking the door and the window.

15. The method of claim 9, further comprising:
based on detection of opening of a locked door of the vehicle from an outside of the vehicle, unlocking the locked door and a window associated with the locked door.

16. A vehicle comprising:
a sensor configured to detect one or more characteristics of an occupant of a seat of the vehicle;
a processor; and
a memory storing at least one instruction that, when executed by the processor communicating with the memory, is configured to cause the vehicle to:
classify, based on the detected one or more characteristics from the sensor, the occupant of the seat of the vehicle as one of:
an adult;
a child;
an infant/toddler; or
a pet; and
selectively control, based on the classification of the occupant, activation of a power lock of at least one of a door associated with the seat or a window associated with the seat.

17. The vehicle of claim 16, wherein the sensor comprises a camera and wherein the one or more characteristics comprise one or more of a seated height of the occupant, a shape of the occupant, a dimension of the occupant or a position of the occupant in the seat.

18. The vehicle of claim 17, wherein the sensor further comprises a radar configured to generate, based on the one or more characteristics, a seat occupancy signal indicating the occupant in the seat.

19. The vehicle of claim 16, wherein the sensor comprises a weight sensor in the seat of the vehicle, and wherein the one or more characteristics comprise a load detected by the weight sensor.

20. The vehicle of claim 16, wherein the at least one instruction that, when executed by the processor communicating with the memory, is configured to cause the vehicle to selectively control activation of the power lock by one or more of:
activating a power lock for the door and the window based on the occupant being classified as an infant/toddler or a pet;
activating the power lock for the door and deactivating the power lock for the window based on the occupant being classified as a child; or
deactivating the power lock for the door and the window based on the occupant being classified as an adult.
